(19) United States
(12) Patent Application Publication
(10) Pub. No.: US 2026/0312049 A1
(43) Pub. Date: Oct. 8, 2026

(54) BATTERY REACTION AUXILLIARY MATERIAL, POSITIVE ELECTRODE OR NEGATIVE ELECTRODE INCLUDING SAME, LITHIUM ION BATTERY INCLUDING SAID POSITIVE ELECTRODE OR NEGATIVE ELECTRODE, AND ELECTRODE MANUFACTURING METHOD

(71) Applicant: 3DC Inc., Sendai-shi, Miyagi (JP)

(72) Inventors: Atsuo OMARU, Miyagi (JP); Masaru IDEN, Miyagi (JP); Togo YAMAGUCHI, Miyagi (KR)

(21) Appl. No.: 19/483,679

(22) PCT Filed: Oct. 31, 2024
(86) PCT No.: PCT/JP2024/038902

§ 371 Date: Nov. 12, 2025

(30) Foreign Application Priority Data
Nov. 1, 2023 (JP) 2023-187914

(51) Int. Cl. H01M 4/587; H01M 4/02; H01M 4/04; H01M 4/133; H01M 4/1393; H01M 10/0525

(52) U.S. Cl. CPC H01M 4/587; H01M 4/0404; H01M 4/043; H01M 4/133; H01M 4/1393; H01M 10/0525; H01M 2004/021; H01M 2004/027; H01M 2004/028

(57) ABSTRACT

Provided are a battery reaction auxiliary material that can suitably assist a battery reaction and may enable extension of the life of lithium-ion batteries, a cathode or an anode containing the battery reaction auxiliary material, a lithium-ion battery having the cathode or the anode, and a manufacturing method of an electrode. The battery reaction auxiliary material includes a plurality of primary particles, each of the primary particles including a carbonaceous substance and having a three-dimensional frame internally including a space, some of the plurality of primary particles are adhered to each other to form a secondary particle, and the secondary particle is plastically deformed in an ultra-micro loading and unloading test, and a part of the secondary particle is not restored. The carbonaceous substance may include graphene.

### TECHNICAL FIELD

The present invention relates to a battery reaction auxiliary material, a cathode or an anode containing the battery reaction auxiliary material, a lithium-ion battery having the cathode or the anode, and a manufacturing method of an electrode.

### BACKGROUND ART

Lithium-ion batteries have expanded their applications over a wide range in daily life, such as smartphones, electric vehicles (EVs), and the like since the birth thereof. As a result, in manufacturing of lithium-ion batteries, there is a continuing demand for higher performance in the market along with cost competitiveness. In preserving the global environment, an increase in the EV driving range is one of the necessary conditions for EVs, which less discharge carbon dioxide (CO₂), to replace gasoline-powered vehicles. To increase the driving range of EVs, it is necessary to achieve a longer life and higher performance of on-vehicle lithium-ion batteries or battery reactions at higher efficiency.

Typically, used lithium-ion batteries have been discarded at the end of their lives. In recent years, however, there has been a growing movement to secure resources and materials on a global scale to seek for manufacturing and stable supply of lithium-ion batteries. To address this, there have been loud calls for necessity of making use of materials in an urban mining manner by reusing used lithium-ion batteries by way of resource recycling.

Resource recycling or remanufacturing of lithium-ion batteries requires substantially the same energy as in the case of manufacturing new products from raw materials. Further, since substantially the same amount of CO₂ is also re-discharged, it is not easy to stop destruction of the global environment even with resource recycling or remanufacturing. Thus, there is a stronger demand for higher performance or a longer life of lithium-ion batteries.

Patent Literature 1 discloses powder for cathodes in which the powder includes an active material containing Ni, Mn, and Fe that enables application to non-aqueous electrolyte rechargeable batteries, and the powder can exhibit excellent discharge characteristics at a higher current rate. Patent Literature 2 discloses a non-aqueous electrolyte rechargeable battery having an anode with an anode active material made of lithium titanate that can prevent the battery characteristics from decreasing even when charged at micro-current about 1 to 5 μA while a constant voltage state at around 3.0V is maintained for a long period of time.

Non-Patent Literature 1 discloses electrolyte motion in a circular cylindrical lithium-ion battery. During charging, the anode material particles expand when lithium ions are inserted into the anode material such as graphite. When lithium ions are extracted during the next discharge, the anode material particles contract, and this also changes voids inside the electrode. Motion, that is, pushing out or re-impregnation of the electrolyte solution present in the voids inside the electrode occurs in accordance with a change of the voids. In such a way, the amount or the position of the electrolyte solution present in the electrode becomes uneven, which is considered to be one of the causes of charge/discharge cycle degradation.

### CITATION LIST

### Patent Literature

### [PTL 1]

Japanese Patent Application, Publication No. 2011-216472

### [PTL 2]

Japanese Patent Application, Publication No. 2005-317509

### Non Patent Literature

### [NPL 1]

C. P. Aiken, et. al., Journal of The Electrochemical Society, 2023, 170, 040529

### SUMMARY OF INVENTION

### Technical Problem

In the rechargeable battery disclosed in Patent Literature 1, however, the battery energy density is reduced because of an excessively large amount of a conductive agent added for obtaining sufficient characteristics. Further, the binder is also insufficient, and this reduces the electrode strength, which results in a shorter life. The rechargeable battery disclosed in Patent Literature 2 has a longer duration time in a constant voltage state but disadvantageously has a lower voltage and has a lower energy density. Therefore, the arts disclosed in Patent Literature 1 and Patent Literature 2 would be unsuitable for applications for EVs or the like. Development of a rechargeable battery that can be operated for a longer period of time and has higher performance is one of the pressing issues.

In increasing the performance of lithium-ion batteries, increasing the life of lithium-ion batteries is an essential theme for seeking true environmental preservation. Various mechanisms of performance degradation of lithium-ion battery products have been studied. Degradation reaction phenomena of lithium-ion batteries are found in various ways, such as alteration of active materials, contact failure of electrode materials, alteration of electrolyte solution components and reduction in the ion amount due to side reactions during degradation, blockage of separator pores by side reaction products, corrosion of current collecting metal components, all of which may cause an increase in the resistance in battery reactions. In addition, Non-Patent Literature 1 reports that promotion of degradation reaction of batteries is caused by the fact that voids within the electrode increases and decreases due to expansion and contraction of the electrode active material during a battery reaction, the amount of the electrolyte solution of the electrode within the battery increases and decreases (electrolyte motion), this results in an uneven amount of the electrolyte solution present therein, and an increased resistance generates an over voltage.

Among other things, an increase in the electrode resistance, which can be said as the root of degradation causes and aggregation of the degradation reaction phenomena, is caused by disconnection of the electron supply network to active materials required for insertion and extraction of lithium ions inside the electrode, delay in supply of lithium ions due to a reduction in the amount of the electrolyte solution, or the like. This poses a major problem of inhibiting extension of the life of lithium-ion battery.

The present invention has been made in view of such circumstances and intends to provide a battery reaction auxiliary material that can suitably assist a battery reaction and may enable extension of the life of lithium-ion batteries and provide a cathode or an anode containing the battery reaction auxiliary material, a lithium-ion battery having the cathode or the anode, and a manufacturing method of the battery reaction auxiliary material.

### Solution to Problem

To solve the above problem, the battery reaction auxiliary material of the present invention employs the following solutions.

The first aspect of the present invention provides a battery reaction auxiliary material including a plurality of primary particles, each of the primary particles including a carbonaceous substance and having a three-dimensional frame internally having a space, some of the plurality of primary particles are adhered to each other to form a secondary particle, and the secondary particle is plastically deformed in an ultra-micro loading and unloading test, and a part of the secondary particle is not restored.

In the above first aspect, the carbonaceous substance may include graphene.

In the above first aspect, the plastic deformation power may be greater than or equal to 5% and less than or equal to 92%.

In the above first aspect, the battery reaction auxiliary material may have an electron transferring function and an electrolyte retaining function as a battery reaction auxiliary function.

In the above first aspect, a pore volume measured by a gas adsorption method may be greater than or equal to 1 cc/g and less than or equal to 6 cc/g.

In the above first aspect, the carbon layer stacking index may be greater than or equal to 0.4 and less than or equal to 5.

In the above first aspect, the secondary particle may be hollow, and a solid particle may be mixed to the secondary particle.

In the above aspect, the solid particle may be at least one of carbon black, acetylene black, single-wall carbon nanotubes, and multi-wall carbon nanotubes.

In the above aspect, the solid particle may be formed of a ceramic particle covered with a carbonaceous substance.

In the above first aspect, the average particle size of the secondary particle may be greater than or equal to 0.1 μm and less than or equal to 6 μm.

The second aspect of the present invention provides a cathode or an anode used for a lithium-ion battery, and the content of the battery reaction auxiliary material according to the above first aspect is greater than or equal to 0.1% by weight and less than or equal to 5% by weight.

The above second aspect may comprise a permanently deformed portion in a part of the structure of the cathode or the anode for the lithium-ion battery, the secondary particle of the battery reaction auxiliary material being permanently deformed to be the permanently deformed portion.

The above aspect may include multi-layer graphene in the permanently deformed portion.

The third aspect of the present invention provides a cathode or an anode used for a lithium-ion battery and including only the solid particle as the battery reaction auxiliary material.

The fourth aspect of the present invention provides a lithium-ion battery including at least one of the cathode and the anode used for a lithium-ion battery according to the above second aspect or third aspect.

The fifth aspect of the present invention provides a manufacturing method of a cathode or an anode used for a lithium-ion battery, the manufacturing method including steps of: mixing a battery reaction auxiliary material, a binder resin, and a solvent to prepare slurry, the battery reaction auxiliary material containing a plurality of primary particles and a secondary particle having the plurality of primary particles adhered to each other, each of the primary particles including a carbonaceous substance and having a three-dimensional frame internally including a space; and applying the slurry onto a current collector, drying the slurry, and performing press machining on the dried slurry and the current collector to obtain a cathode or an anode, and in the press machining, the shape of a part of the primary particles and the secondary particle remains deformed, and the shape of another part of the primary particles and the secondary particle is restored.

### Advantageous Effects of Invention

According to the battery reaction auxiliary material of the present invention, the battery reaction can be suitably assisted. The lithium-ion battery having the cathode or the anode containing the battery reaction auxiliary material according to the present invention enables an extended life and higher performance.

### BRIEF DESCRIPTION OF DRAWINGS

FIG. 1 is an enlarged schematic diagram of a part of the structure of an electrode containing a battery reaction auxiliary material according to one embodiment of the present invention.

FIG. 2 is a diagram illustrating Raman spectrum measured for an auxiliary material of Example 1.

FIG. 3A is a SEM photograph (in 20 μm scale) of an electrode surface before pressed in manufacturing of a cathode of Example 1.

FIG. 3B is a SEM photograph (in 1 μm scale) of the electrode surface before pressed in the manufacturing of the cathode of Example 1.

FIG. 3C is a SEM photograph (in 20 μm scale) of the electrode surface after pressed in the manufacturing of the cathode of Example 1.

FIG. 3D is a SEM photograph (in 1 μm scale) of the electrode surface after pressed in the manufacturing of the cathode of Example 1.

FIG. 4 is a diagram illustrating a result obtained when an ultra-micro loading and unloading test was performed on the battery reaction auxiliary material produced in Example 1.

FIG. 5 is a diagram illustrating one example of the sectional structure of a lithium-ion battery according to one embodiment of the present invention.

FIG. 6 is a transmission electron microscopy (TEM) image of the battery reaction auxiliary material obtained in Example 1.

FIG. 7 is a TEM image of the battery reaction auxiliary material obtained in Example 2.

FIG. 8 is a diagram illustrating a pore diameter distribution curve of the battery reaction auxiliary material obtained in Example 1.

FIG. 9 is a diagram illustrating a particle size distribution curve of the battery reaction auxiliary material obtained in Example 1.

FIG. 10 illustrates a discharge curve when a test battery of Example 1 according to one embodiment of the present invention was used, which is a diagram illustrating a difference in current during discharge.

FIG. 11 is a TEM photograph of the battery reaction auxiliary material obtained in Example 6.

FIG. 12 is a diagram illustrating a relationship between the plastic deformation power and the 2C-rate discharge retention rate for a test battery according to an Example and a test battery according to a Comparative example.

FIG. 13 is a diagram illustrating a relationship between the carbon layer stacking index and the 2C-rate discharge retention rate for the test battery according to an Example and the test battery according to a Comparative example.

FIG. 14 is a diagram illustrating a relationship between the pore volume and the 2C-rate discharge retention rate for the test battery according to an Example and the test battery according to a Comparative example.

FIG. 15 is a diagram illustrating a relationship between the secondary particle diameter inside the auxiliary material and the 2C-rate discharge retention rate for the test battery according to an Example and the test battery according to a Comparative example.

FIG. 16 is a diagram illustrating a relationship between the additive amount of the auxiliary material and the charge and discharge capacity for the test battery according to an Example and the test battery according to a Comparative example.

### DESCRIPTION OF EMBODIMENTS

One embodiment of a battery reaction auxiliary material, a cathode or an anode used for a lithium-ion battery and containing the battery reaction auxiliary material, and a lithium-ion battery having the cathode or the anode according to the present invention will be described below with reference to the drawings.

First, the battery reaction auxiliary material according to the present embodiment will be described.

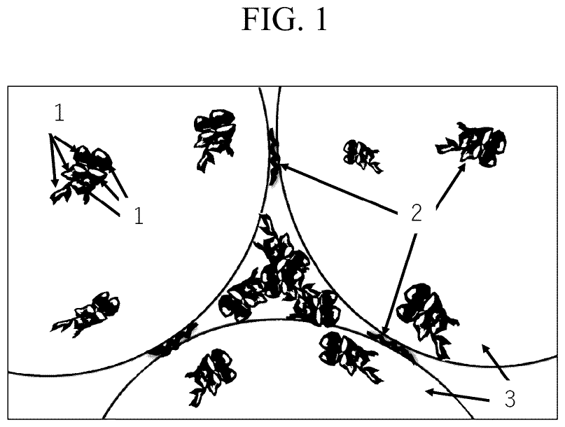

FIG. 1 represents an enlarged schematic diagram of a part of the structure of an electrode containing a battery reaction auxiliary material (hereafter, also referred to as “auxiliary material”) according to the present embodiment. The battery reaction auxiliary material of the present embodiment is contained in the anode or the cathode of a lithium-ion battery, for example. FIG. 1 illustrates an example in which the battery reaction auxiliary material of the present embodiment is applied to the cathode.

As seen in FIG. 1, the auxiliary material of the present embodiment includes primary particles 1 and secondary particles 2 formed with a plurality of primary particles adhered thereto. Each primary particle 1 contains a carbonaceous substance, and the carbonaceous substance includes a thin-layer graphene substance described later. The primary particle 1 is a hollow particle having a three-dimensional frame and having a space therein. Each reference 3 in FIG. 1 denotes a cathode material.

The auxiliary material of the present embodiment includes a thin-layer graphene substance. Graphene has a sheet-like structure obtained as a result of planar growth of a carbon hexagonal network surface in which benzene rings are bound. Graphite is multi-layered graphene. On the other hand, a structure that is elastically deformable due to a small number of layers while a carbon hexagonal network surface has been planarly grown is defined as a thin-layer graphene substance in the present specification. The thin-layer graphene substance is the main structure of the auxiliary material of the present embodiment.

When a stress is loaded to primary particles and secondary particles of the present embodiment, a three-dimensional shape of the thin-layer graphene substance portion is mainly compressed and deformed in the particles. When the loaded stress is unloaded, however, the deformed portion is restored at a certain rate due to the elastic deformability thereof. The portion not restored even when unloaded is a portion having low elasticity. When the portion made of the thin-layer graphene substance includes many structural defects or includes many amorphous bonds, the shape is not restored, that is, the portion is plastically deformable to stress. Such a structural part that is plastically deformable to stress exhibits a high strength against stress or has a nature of being easily deformed and not restored thereafter.

As described above, in the auxiliary material of the present embodiment, the thin-layer graphene substance portion is elastically deformable, and the portion other than the thin-layer graphene substance is an amorphous carbon and is plastically deformable. The primary particles of the auxiliary material of the present embodiment are deformed when loaded with stress. For a certain level of loaded stress, while the shape of some of the plurality of primary particles is restored when unloaded, permanently deformed state of other particles of the plurality of primary particles is maintained. This dynamic property is caused by the effect of the micro-structure of the carbonaceous substance. The degree of elastic deformation and the degree of plastic deformation of the auxiliary material can be measured by an ultra-micro loading and unloading test described later.

When the thin-layer graphene substance is relatively thick, the portion of the thin-layer graphene substance maintains the elastic deformability within a certain stress range but is plastically deformed at once when the stress exceeds a predetermined threshold. In some cases with general carbon materials, deformation may occur due to a certain level of large stress, and the particles may be destroyed. That is, it can be said that the auxiliary material of the present embodiment has a nature of returning to its original shape with little deformation under a low stress such as the stress in the ultra-micro loading and unloading test performed in the present embodiment, that is, a nature of a large elastic deformation workload.

It can be said that graphene is a carbonaceous substance having high electron conductivity due to the hexagonal planar structure with high regularity.

Herein, the state in the microcrystal structure of the thin-layer graphene substance can be analyzed in Raman spectrum measurement.

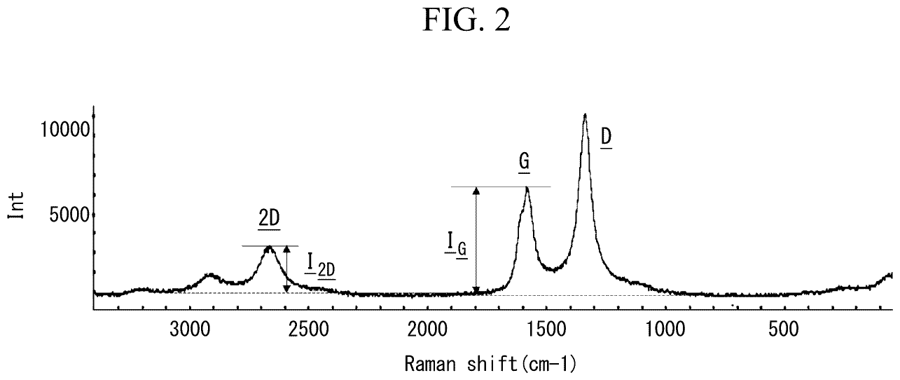

FIG. 2 illustrates an example of the Raman spectrum measured for an auxiliary material of Example 1 described later. In this spectrum, there are a G-band derived from frame vibration of the graphite sheet (aromatic ring C═C stretching movement, 1593 cm⁻¹), a D-band derived from a defect such as a non-hexagonal site including an edge site (C—H stretching movement, 1356 cm⁻¹), and a 2D-band derived from secondary phonon scattering (C—H stretching movement, 2680 cm⁻¹). From these facts, it is implied that the auxiliary material of Example 1 has a structure containing graphene. The value I_{G}/I_{2D}, which is a ratio of the intensity of G-band (I_{G}) and the intensity of 2D-band (I_{2D}), is said to be an index indicating the layered state of a graphene layer (D. Graf, et al., NANO LETTERS, 7, 238-242; (2007)). In the present embodiment, the index represented by I_{G}/I_{2D} is referred to as “carbon layer stacking index”. The value per layer was set to 0.2 with reference to the above paper.

A smaller value of I_{G}/I_{2D}, that is, a smaller carbon layer stacking index results in a smaller number of layers, and the structure is closer to a single-layer graphene. That is, it is implied that the auxiliary material has the structure exhibiting elastic deformability. The expression “when the thin-layer graphene substance is relatively thick” in the present specification means a case where the carbon layer stacking index of particles in the auxiliary material indicates a value greater than 6.

The auxiliary material of the present embodiment is excellent in electron transfer due to inclusion of graphene. Thus, when contained in an electrode of a lithium-ion battery, the auxiliary material of the present embodiment can achieve a function of assisting a battery reaction in the lithium-ion battery. Further, the auxiliary material of the present embodiment is excellent in ion supply during a reaction, because an electrolyte solution in which lithium ions have been dissolved is impregnated and retained in a space provided in the three-dimensional frame of the primary particles and the secondary particles.

Therefore, in the auxiliary material of the present embodiment, it is possible to make use of elastic deformation and plastic deformation in a well-balanced manner under the operation condition of a lithium-ion battery. That is, while the high electron conductivity is ensured even when the primary particles and/or the secondary particles in the auxiliary material are plastically deformed, the electrolyte solution serving as a storage source of ions is stored in the space inside particles when these particles are not plastically deformed. Thus, the auxiliary material of the present embodiment may suitably assist a battery reaction.

A manufacturing method of the auxiliary material of the present embodiment will be described. The auxiliary material of the present embodiment can be produced by a template chemical vapor deposition method (hereafter, referred to as T-CVD method). This is a scheme to cause an organic gas to flow through ceramics having CVD activity and heated in an inert gas atmosphere and condense carbon atoms of an organic substance mainly in the gas to form a carbonaceous film.

Next, to provide space in primary particles, ceramic particles each covered with a carbonaceous film are treated with a reagent that can dissolve ceramics (for example, an acid solution). Due to this treatment, ceramics portions of the ceramic particles covered with the carbonaceous film are eluted and removed. After the elution, the interior of each primary particle formed from the carbonaceous substance is washed so that no residual is present in the space. Because the ceramic particles are dissolved and removed, spaces are formed inside the primary particles formed from carbonaceous substance.

Next, the primary particles are subjected to heat treatment at 3000° C. or lower to adjust structural defects of the thin-layer graphene substance portion or the portion other than the thin-layer graphene substance portion forming the particles. Such structural defects include spaces created inside particles due to elution of a template and entry holes created in the three-dimensional frames formed from a carbonaceous substance. By adjusting reaction conditions such as a heat treatment temperature or a heat treatment time, it is possible to adjust the degree of these structural defects. That is, it is possible to adjust the size of the space present inside a particle or the size of an entry hole used for causing an electrolyte solution to enter a particle.

Functional groups binding to carbon (mainly, oxygen-containing functional groups) or carbon chains that do not form a six-membered ring are dissociated above about 1000° C., and dangling bonds are formed. Once the formed dangling bonds is bound to another carbon nearby, the surface of the carbon material is in a state where the functional group is less likely to bind thereto. With the heat treatment at 1500° C. or higher, preferably 1600° C. or higher, the auxiliary material of the present embodiment can achieve suitable functions such as maintaining electron conductivity or internal spaces.

The auxiliary material of the present embodiment has a pore volume of 1 cc/g or greater and 4 cc/g or less as measured by a gas adsorption/desorption method, specifically, nitrogen adsorption measurement. The pore volume represents a volume of a space present inside a particle. A larger value of the pore volume results in a larger amount of the electrolyte solution retained inside a particle and higher reaction efficiency. On the other hand, since a large value of the pore volume means a large space, the frame strength is reduced, which makes it difficult to maintain the shape of the particle due to a pressure under load. In the auxiliary material of the present embodiment, the pore volume is more preferably greater than 1 cc/g and less than or equal to 4 cc/g, and much more preferably greater than 1.5 cc/g and less than 4 cc/g. With such a moderate pore volume, the particle has a moderate strength, which contributes to stability of the particle shape, and the shape thereof is maintained. Because of the above, the electron conductivity and the ability of supplying ions retained inside pores can be maintained in a well-balanced manner.

The cathode material of the lithium-ion battery is lithium-containing transition metal oxide having low electron conductivity and powder having a particle size distribution. In the conventional method, an electron conduction route is established when a conductive agent made of a carbon material that assists electron conduction for a battery reaction and a binder resin are mixed and then pressurized and fixed to a current collector. Since materials other than the binder resin are powder particles, the electrolyte solution may be only accidentally present in the space present between particles. It is thus difficult for the conventional art to positively arrange the electrolyte solution, in other words, lithium ions near the cathode material.

In contrast, the present embodiment uses a battery reaction auxiliary material instead of the conventionally used conductive agent. The battery reaction auxiliary material of the present embodiment is formed of particles mainly made of the thin-layer graphene substance and, inside the particles, has a space that can retain an electrolyte solution therein. The auxiliary material achieves high electron conductivity due to the graphene substance though being permanently deformed if it is pressurized between particles of the cathode material inside the cathode electrode or the like, however, the space retaining lithium ions can be maintained unless it is deformed. Therefore, the battery reaction auxiliary material of the present embodiment can be said to be a material that can assist supply of electrons and ions simultaneously that are necessary for a battery reaction and more suitably realize a quick battery reaction.

In the auxiliary material of the present embodiment, the three-dimensional frame is deformed by a pressure. When the soft graphene substance portion is collapsed, the single-layer graphene changes to a multi-layered state. This provides good electron conduction.

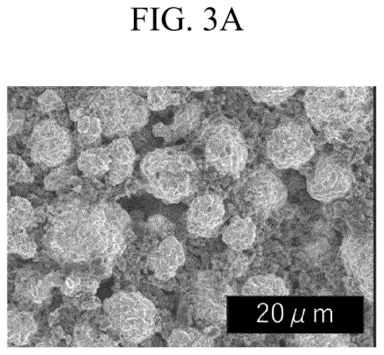

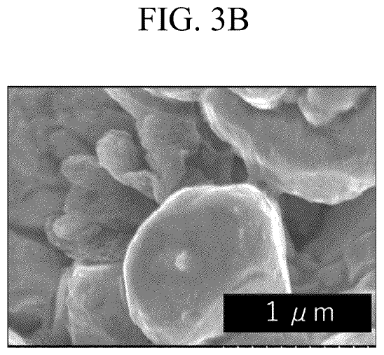

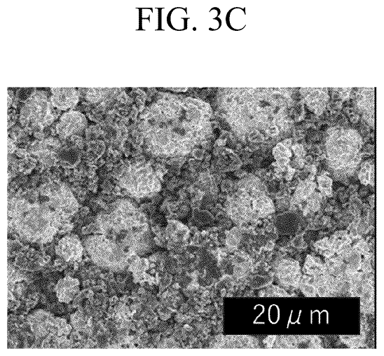

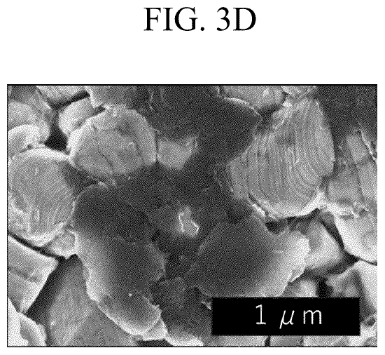

In the actual electrode, for example, cathode mixture slurry is applied to and dried on a current collector, press machining is then performed thereon, and thereby the mixture layer is flattened. When the electrode contains the auxiliary material of the present embodiment, particles interposed between the cathode material particles are directly subjected to the stress, thereby is plastically deformed, and exhibits high electron conductivity. Along therewith, particles present in gaps of the cathode materials and not subjected to the stress are present as particles maintaining the space therein and exhibit the function of retaining the electrolyte solution. As an example, FIG. 3A and FIG. 3B represent SEM photographs of the electrode surface before the pressing machining in the present embodiment, and FIG. 3C and FIG. 3D represent SEM photographs of the electrode surface after the press machining. From comparison between FIG. 3A and FIG. 3C and comparison between FIG. 3B and FIG. 3D, it can be seen that the structure is created in which some primary particles and secondary particles are collapsed by the pressing. The collapsed portion corresponds to the permanently deformed portion described above.

The auxiliary material of the present embodiment includes the primary particles that are hollow particles having spaces therein. On the other hand, when compositions or the like in the electrode are selected, the electrode void rate is adjusted without an increase of the electrode density, or the like, solid particles can be mixed to the follow particles for use. The solid particles are those remaining without elution of the template in the T-CVD method described above.

The solid particle is preferably a carbonaceous substance in terms of electron conductivity, and carbon black, acetylene black, single-wall carbon nanotubes, or multi-wall carbon nanotubes are suitably used.

In the auxiliary material according to the present embodiment, it is preferable that the solid particles be ceramic particles covered with a carbonaceous substance. In producing high-density electrodes, ceramic particles have higher strength than carbon-based particles. Accordingly, the structure of the electrode containing the auxiliary material can be reinforced, and electron conductivity can be improved due to addition of conductivity of the carbonaceous substance.

When ceramic particles are selected for the solid particles, the solid particles can be used directly without elution by the reagent described above.

As the ceramic particles, compounds inactive to a battery reaction can be selected as appropriate. Examples thereof may be, Al₂O₃, MgO, SiO₂, ZrO₂, or the like. Another example may be ceramic particles that have CVD activity and can be used as the template for the T-CVD method.

Further, other than the strength, various properties of ceramic particles can be utilized. Examples of properties may be, a chemical reactivity, a catalysis property, a physical property, or the like.

Although depending on the purpose of use, the ratio of mixture of the solid particles to auxiliary material is preferably 10% by weight or greater, more preferably 30% by weight or greater, most preferably 50% by weight or greater for distinctively achieving efficacy.

When the solid particles are mixed to the auxiliary material, carbon-based solid particles can be mixed as appropriate for use in order to finely adjust the electrode specification. By adding the carbon-based solid particles, it is possible to adjust the electron conductivity of the auxiliary material.

In some cases, a lithium-ion battery may be possible that has an electrode in which all the hollow particles described above are replaced with the solid particles having ceramic particles covered with a carbonaceous substance. In terms of the battery reaction, even when the lithium-ion battery having the electrode including the auxiliary material in which the solid particles are replaced with the solid particles having ceramic particles covered with a carbonaceous substance is used, no significant difference is found in the battery reaction from the lithium-ion battery including the auxiliary material with hollow particles. Replacement of the hollow particles with the solid particles having ceramic particles covered with a carbonaceous substance is preferable for exhibiting another new function property.

As the electrode active material, lithium-containing oxides, lithium transition metal phosphates, or the like can be used for the cathode, and alloys or intermetallic compounds containing graphite, carbons, Si, Sn, or the like can be used for the anode.

The auxiliary materials of the present embodiment are the primary particles or the secondary particles to which at least a plurality of primary particles are adhered to each other. Although depending on the type of the electrode active material, it is preferable for the primary particle and the secondary particle to have a length that is less than or equal to twice the particle diameter of the electrode active material.

Although depending on which functionality of the primary particles or the secondary particles is prioritized in the auxiliary material, particles having an average particle size that is greater than or equal to 0.05 μm and less than or equal to 0.6 μm can be suitably used as the secondary particles. The average particle size of the secondary particles is more preferably greater than or equal to 0.1 μm and less than or equal to 5 μm.

Further, for the auxiliary material of the present embodiment, it is not possible to externally, newly supply lithium ions, which are the source of the battery capacity. Thus, the addition rate of the auxiliary material to the electrode should be within the minimum necessary. To obtain suitable properties, it is preferable for the auxiliary material to be greater than or equal to 0.1% by weight and less than or equal to 5% by weight with respect to the electrode mixture.

The addition rate less than this range is not preferable because the functionality of the auxiliary material is unable to be exerted, and an excessively large addition rate is not preferable because the bulk density of the electrode mixture becomes excessively large and the electrode strength is reduced.

Next, measurement in the ultra-micro loading and unloading test for observing the physical property of the battery reaction auxiliary material according to the present embodiment will be described.

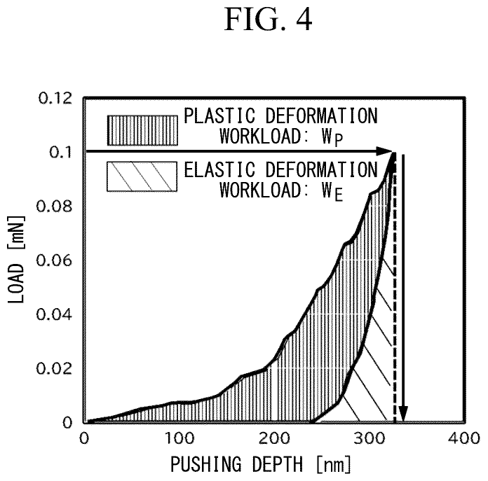

As one example of the ultra-micro loading and unloading test, FIG. 4 illustrates a load displacement curve obtained when the test was performed on a battery reaction auxiliary material produced in Example 1 described later. In the ultra-micro loading and unloading test used in the present embodiment, an indenter is abutted against and pushed into sample particles, and thereby a load is applied to the sample particles. The measurement is started at the time the indenter comes into contact with the particles and a sensor detects a pressure. Then, as the pushing depth increases, the load to the particles increases. In the ultra-micro loading and unloading test in the present embodiment, the load is unloaded at the time the load reaches 0.1 mN.

If the particles are not deformed at all and the shape thereof is completely recovered, the pushing depth returns to 0, that is, returns to near the origin on the horizontal axis of the graph of FIG. 4. In contrast, if the particles are completely deformed by the load, that is, the particles are collapsed in the direction of application of load, the pushing depth remains at 300 nm. This means that the particle is in a state where the space present inside the particle disappears and two layers forming the frame are overlapped.

In the battery reaction auxiliary material of the present embodiment, the pushing depth did not return to 0 even after unloaded, and in FIG. 4, for example, the pushing depth remained at around 230 nm in the particle to which the load was applied. This indicates that the particle is in a state where, while the particle is partially deformed by the load, the space inside the particle remains. In FIG. 4, the portion corresponding to the workload by which the shape was recovered against the applied load represents an elastic deformation workload W_{E} (the diagonal-lined part of FIG. 4), and the portion corresponding to the workload by which the particle is deformed by the applied load represents a plastic deformation workload W_{P} (the vertical-lined part of FIG. 4).

The carbon layer stacking index of the auxiliary material of the present embodiment is preferably 5 or less. If the carbon layer stacking index is greater than this, the frame of the particle becomes harder, and this results in a smaller elastic deformability of the particle structure. The particle is likely to be destroyed by a pressure during electrode production, and the amount of the retained electrolyte solution is reduced, which results in degradation in properties. If the carbon layer stacking index is excessively small, the particle is likely to collapse when loaded. This means that the space inside the particle is reduced, and accordingly, the electrolyte solution is less likely to be retained inside the particle.

Next, the lithium-ion rechargeable battery having the electrode containing the auxiliary material of the present embodiment will be described.

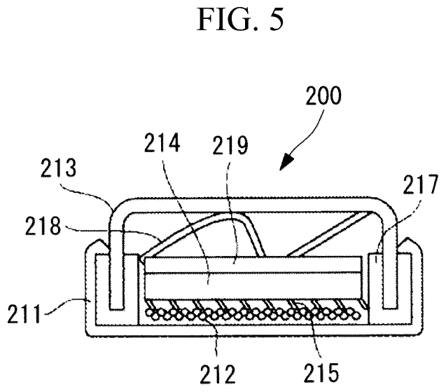

FIG. 5 illustrates an example of the sectional structure of a coin cell lithium-ion battery 200 according to one embodiment of the present invention. The lithium-ion battery 200 has a disk-like cathode 212 accommodated in a metal exterior component 211 and a disk-like anode 214 accommodated in a metal exterior component 113 stacked together via a separator 215 therebetween. Note that a metal spring 218 and a spacer 219 are arranged between the exterior component 213 and the anode 214. The exterior component 211 and the exterior component 213 are filled with a liquid electrolyte, and peripheral edges of the exterior component 211 and the exterior component 213 are sealed by being caulked via a sealing gasket 217.

The cathode will be described.

In general, the cathode 212 is obtained by applying slurry made of a mixture of a metal oxide-based material, a conductive agent for assisting electron conductivity, a binding agent, and a solvent onto a current collecting metal foil such as a rolled aluminum foil, thereby forming a coated film, heating and drying the coated film to remove the solvent, and then forming the coated film into predetermined dimension and density. In the present embodiment, the battery reaction auxiliary material described above is used without the use of a generally used conductive agent such as acetylene black.

A metal compound-based material that can be used for a cathode active material is a material that can release electrons to an external circuit of the battery and release Li ions to an electrolyte at the same time. While the amount of contained Li ions varies in accordance with the chemical composition, crystal structure, or the like thereof, it is preferable to use a material that can reversibly take in and out a large amount of Li ions.

Examples of the material may be transition metal oxides, composite oxides of lithium and transition metals, transition metal sulfides, or the like. As the transition metal, Fe, Co, Ni, Mn, or the like are used. Specific examples may be transition metal oxides such as MnO, V₂O₅, V₆O₁₃, and inorganic compounds such as TiO₂, LiNiO₂, LiCoO₂, LiMn₂O₄, and TiS₂, FeS, and MoS₂. To improve their characteristics, transition metal oxides in which a particular element thereof is partially substituted with a certain element may be used.

In addition to the inorganic compounds described above, cathode materials made of organic compounds can be also used. For example, polyaniline, polypyrrole, polyacene, disulfide-based compounds, polysulfide-based compounds, N-fluoropyridinium salts, or the like may be used. The cathode materials may be a mixture of the inorganic compounds and the organic compounds described above.

The physical properties of the cathode material are determined from requirement items for battery design and manufacturing process due to constraint conditions such as a usage form of the lithium-ion battery. In manufacturing of the cathode material, process design or the like have been made to be able to achieve desired physical properties thereof. Examples of physical property values may be powder particle diameter and distribution, a specific surface area, a density, or the like.

As an example, the powder particle diameter is selected as appropriate under consideration on other composition requirements of the lithium-ion battery, and is typically, preferably 1 to 30 μm, more preferably 1 to 10 μm as an average value in terms of improvement in battery characteristics such as rate characteristics or cycle characteristics.

Since the cathode materials described above have generally low electron conductivity, it is preferable that the battery reaction auxiliary material for assisting the electron conductivity coexist within the cathode. As a material of the generally used conductive agent, carbon-based materials and metal-based materials as well as other materials having high electron conductivity can be used, and the carbon-based materials are suitable among these materials.

The amount of the battery reaction auxiliary material to coexist has to be the minimum necessary, and the content of the cathode material that defines the capacity of the lithium-ion battery has to be increased to the maximum.

Conventional carbon-based materials may be soot, acetylene black, Ketjen black, lamp black, furnace black, carbon black, graphite, carbon fiber, graphite fiber, nanofiber, nanotube, coke, hard carbon, amorphous carbon, or the like.

Compared to the above, the auxiliary material of the present embodiment has significant features that are not present in the conventional material. In other words, the auxiliary material of the present embodiment contains a relatively large area of graphene in the structure, so there are few defects other than carbon-carbon bonds, such as oxygen-containing functional groups, at the end of the six-membered ring carbon bond. Thus, the auxiliary material is less likely to be degraded and decomposed in an electrochemical oxidizing environment to which the auxiliary material is exposed in the battery.

Further, if necessary, a further efficacy can be obtained in combined use with the conventional material described above. For example, thin strip-like graphite, highly linear carbon nanotubes, or the like have high electron conductivity but have a low ion storage ability. The combination of the above material having such a nature with the auxiliary material of the present embodiment makes it possible to construct a suitable battery reaction assisting system in which ion storage ability is added to electron conductivity.

Further, carbon blacks such as acetylene black are formed of connected structural particles having a diameter of several tens of nanometers. On the other hand, the carbon blacks are not suitable for long distance transfer of electrons, because the carbon blacks have not very high crystallinity of carbon, also have a short structural length, and easily collapse. Combination of the carbon blacks with the auxiliary material of the present embodiment can realize a system that maintains electron conductivity and also has an ion supply ability even when the steric structure is maintained or when the steric structure is collapsed and flattened as with flake graphite.

The ratio suitable for containing the battery reaction auxiliary material made of the carbon material of the present embodiment in the cathode varies in accordance with a difference in a type of the cathode material, a type and an amount of a binder, battery capacity design, or the like. In the present embodiment, as described above, the addition rate of the battery reaction auxiliary material to the cathode is preferably greater than or equal to 0.1% by weight and less than or equal to 5% by weight per electrode mixture. With the addition in such a range, suitable properties can be obtained.

The cathode material and the battery reaction auxiliary material described above are often in a powder form, and to fix particles of the powder to each other and onto the current collecting metal foil, it is preferable to mix a small amount of a binding agent. The binding agent is required to be chemically and electrochemically inactive and have some elastic deformability and affinity, and plastic resin materials are suitably used.

As another usage form of the battery reaction auxiliary material, it can be used in a state of a paint in which powder is dispersed in a liquid solvent at a constant ratio. In such a case, for the solvent, organic or inorganic compounds applicable to manufacturing of lithium-ion batteries can be used. To maintain a good dispersion state of the powder in the solvent, an organic or inorganic dispersion agent (as an example, a monomolecular or plastic resin material) can be suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, and polyacrylamide. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, and preferably 100,000 to 1,000,000. An excessively small molecular weight reduces the strength of the coated film, and an excessively large molecular weight increases the viscosity and makes it difficult to form the electrode.

To sufficiently uniformly distribute the binding agent and to form the slurry to be a coated film having a predetermined dimension, a suitable slurry solvent that dissolves only the binding agent resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

As the current collecting metal foil, materials that are inexpensively available and durable for industrial use are preferred, and materials having electrochemically resistance to a potential developed by the cathode are suitably used. As an example of the current collecting metal foil, aluminum foils, nickel foils, titanium foils, and stainless-steel foils are preferred, and rolled aluminum foils that are easily available in general are more preferred.

As a method of forming the film coated with slurry to a current collecting metal foil, commonly used printing techniques can be used. When the thickness dimension of the coated film is small, printing methods such as gravure printing are suitably used, and when the thickness dimension of the coated film is large, printing methods such as doctor blade printing or die printing are suitably used.

The coated film is then heated and dried. Any drying method can be used, and methods that can achieve a desired binding strength in accordance with a binding agent are suitably used.

Further, when the cathode is then formed into a predetermined dimension, an industrially available cutting blade or the like and the system thereof are suitably used. Further, to achieve a predetermined density, an industrially available pressurizing device or the like and the system thereof are suitably used if necessary.

Next, the anode will be described.

For example, the anode 214 is obtained by coating a current collecting metal foil such as rolled copper foil with slurry made of a mixture of a carbon-based material, a binder, and a solvent, heating and drying the coated material to remove the solvent, and then forming the coated material into predetermined dimension and density.

As the carbon-based materials that can be used for the anode, a material that can bind and stabilize Li ions with electrons flowing in from an external circuit and has a large number of stabilizing sites inside is preferred.

For example, any material originating from an organic substance with high or low crystallinity can be used, and graphite, coke, amorphous carbon, hard carbon, polymer carbon, or the like can be suitably used. In such a case, the principle is that Li ions are held between graphene layers or the like, bound with electrons in this state, and stabilized.

Further, as another stabilizing mechanism, a method of electrochemically forming an intermetallic compound can also be used, and silicon, tin, zinc, bismuth, antimony, cadmium, lead, germanium, or the like can be suitably used.

In addition, other materials exhibiting low electrochemical reaction potentials can also be used to serve as the anode side of the lithium-ion battery. Preferably, the materials may be compounds of metals and oxygen, sulfur, halogen, nitrogen, phosphorus, or the like.

Further, to obtain a particular discharge profile for some applications of the lithium-ion battery, a plurality of anode materials described above can be mixed at a predetermined ratio, and the mixture can be used.

The physical properties of the anode material are determined from requirement items for design of a device (a storage battery as an example) and manufacturing process due to constraint conditions such as a usage form of the lithium-ion battery. In manufacturing of the materials thereof, process design or the like have been made to be able to achieve desired physical properties thereof. Physical property values may be powder particle diameter and distribution, a specific surface area, a density, or the like.

As an example, the powder particle diameter is selected as appropriate under consideration on other composition requirements of the lithium-ion battery, and is typically, preferably 1 to 70 μm, more preferably 3 to 30 μm as an average value in terms of improvement in battery characteristics such as rate characteristics or cycle characteristics.

Although the anode materials described above have generally high electron conductivity, some materials have smooth surfaces, and when contact between particles is insufficient, it is also preferable that a conductive agent for assisting the electron conductivity coexist. As a material thereof, carbon-based materials and metal-based materials as well as other materials having high electron conductivity can be used, and the carbon-based materials are suitable among these materials. The battery reaction auxiliary material of the present embodiment described above may be used as a conductive agent.

The amount of the conductive agent to coexist has to be the minimum necessary, and the content of the anode material that defines the capacity of the lithium-ion battery has to be increased to the maximum.

Conventional carbon-based materials may be soot, acetylene black, Ketjen black, lamp black, furnace black, carbon black, graphite, carbon fiber, graphite fiber, nanofiber, nanotube, coke, hard carbon, amorphous carbon, or the like.

Compared to the above, the battery reaction auxiliary material of the present embodiment has significant features that are not present in the conventional material and, furthermore, if necessary, can obtain further efficacy by combined use with the conventional material. For example, thin strip-like graphite, highly linear carbon nanotubes, or the like have high electron conductivity but have a low ion storage ability. Thus, the combination of the above material with the auxiliary material of the present invention makes it possible to construct a suitable battery reaction assisting system in which ion storage ability is added to electron conductivity.

Further, carbon blacks such as acetylene black are formed of connected structural particles having a diameter of several tens of nanometers. On the other hand, the carbon blacks are not suitable for long distance transfer of electrons, because the carbon blacks have not very high crystallinity of carbon, also have a short structural length, and easily collapse. Although having such natures, the carbon blacks in combination with the auxiliary material of the present invention can realize a system that maintains electron conductivity and also has an ion supply ability even when the steric structure is maintained, when the steric structure is collapsed and flattened as with flake graphite, or the like.

The ratio suitable for containing the battery reaction auxiliary material of the present embodiment in the anode varies in accordance with a difference in a type of the anode material, a type and an amount of a binder, battery capacity design, or the like. In the present embodiment, as described above, the addition rate of the battery reaction auxiliary material to the anode is preferably greater than or equal to 0.1% by weight and less than or equal to 5% by weight per electrode mixture. Suitable properties can be obtained by the addition in such a range.

As the current collecting metal foil, materials that are inexpensively available and durable for industrial use are preferred, and materials not having electrochemically reactivity to a potential developed by the anode are suitably used. As an example of the current collecting metal foil, copper foils, nickel foils, titanium foils, and stainless-steel foils are preferred, and electrolytic copper foils and rolled copper foils that are easily available in general are more preferred.

As a method of forming the film coated with slurry described above, commonly used printing techniques can be used. When the thickness dimension is small, printing methods such as gravure printing are suitably used, and when the thickness dimension is large, printing methods such as doctor blade printing or die printing are suitably used.

The coated film is then heated and dried. Any drying method can be used, and methods that can achieve a desired binding strength in accordance with a binding agent are suitably used.

Further, when the anode is then formed into a predetermined dimension, an industrially available cutting blade or the like and the system thereof are suitably used. Further, to achieve a predetermined density, an industrially available pressurizing device or the like and the system thereof are suitably used if necessary.

The anode material and the conductive agent described above are often in a powder form, and to fix particles of the powder to each other and onto the current collecting metal foil, it is preferable to mix a small amount of binding agent. The binding agent is required to be chemically and electrochemically inactive and have some elastic deformability and affinity, and plastic resin materials are suitably used.

As another usage form of the battery reaction auxiliary material, it can be used in a state of a paint in which powder is dispersed in a liquid solvent at a constant ratio. In such a case, for the solvent, organic or inorganic compounds applicable to manufacturing of lithium-ion batteries can be used. To maintain a good dispersion state of the powder in the solvent, an organic or inorganic dispersion agent (as an example, a monomolecular or plastic resin material) can be suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, polyacrylamide, carboxymethyl cellulose, styrene butadiene rubber, or the like. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, preferably 100,000 to 1,000,000. An excessively small molecular weight reduces the strength of the coated film, and an excessively large molecular weight increases the viscosity and makes it difficult to form the electrode.

To sufficiently uniformly distribute the binding agent and to form the slurry to be a coated film having a predetermined dimension, a suitable slurry solvent that dissolves only the binding agent resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

The electrolyte for the battery applied to the lithium-ion battery in the present embodiment will be described.

The electrolyte is obtained by dissolving a solute in an organic solvent, and typically, the solute and the organic solvent are the main components.

One of the compositions of the electrolyte is primarily a solute that is a source of ions, that is, a Li salt.

The type of the solute is not particularly limited, and any solute can be used as long as it is known to be utilized for the application of such a lithium-ion battery. Specifically, the following can be used.

Examples of the solute may be inorganic salt such as LiPF₆ and LiBF₄, fluorine-containing organic Li salt such as LiCF₃SO₃, LiN(CF₃SO₂)₂, LiN(C₂F₅SO₂)₂, Li cyclic 1,2-perfluoroethane disulfonylimide, Li cyclic 1,3-perfluoropropane disulfonylimide, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂F₅SO₂)₂, LiBF₂(CF₃)₂, LiBF₂(C₂F₅)₂, LiBF₂(CF₃SO₂)₂, and LiBF₂(C₂F₅SO₂)₂, Li bis(oxalate) borate, or the like.

Among the above, LiPF₆, LiBF₄, LiN(CF₃SO₂)₂, and LiN(C₂F₅SO₂)₂ are preferred in terms of exerting battery performance, and LiPF₆ and LiBF₄ are particularly preferred.

Note that these Li salts may be used alone, or two or more of these Li salts may be used in combination.

The content ratio of Li salt in the electrolyte will vary in accordance with the type of the solvent used to dissolve the Li salt or the mixture composition thereof. The content ratio of Li salt in the electrolyte is preferably 7 to 190% by weight, more preferably 10 to 180% by weight, still more preferably 13 to 150% by weight.

Next, organic solvents used for the electrolyte will be described.

The type of the organic solvent is not particularly limited, and the organic solvent can be selected as appropriate from those conventionally known as solvents. For example, cyclic carbonates, chain carbonates, cyclic ethers, chain ethers, cyclic carboxylic acid esters, chain carboxylic acid esters, phosphorus-containing organic solvents, or the like having no unsaturated bond may be used.

Factors that affect the migration of Li ions may be the viscosity and the solvation ability of the organic solvent in addition to viscosity. The solvation ability is the force to dissociate dissolved ions, and since an excessively strong solvation ability inhibits the migration of ions, there is an optimum value.

Further, the operating environment conditions for practical lithium-ion batteries are of a wide range, and in particular, the physical properties of the organic solvent, such as the melting point or the boiling point, are also required to be included within a certain range.

A practical solution to the above requirements is to use a mixture of multiple organic solvents. The mixture composition thereof is determined by taking practical characteristics into consideration from combinations of physical properties such as the organic solvent having a high melting point, the organic solvent having a low melting point, the organic solvent having a high solvation ability, the organic solvent having a low solvation ability, or the like.

In the electrolyte of the present embodiment, it is preferable to mix cyclic carbonates and chain carbonates, both of which do not have carbon-carbon unsaturated bonds.

The cyclic carbonate may be alkylene carbonates having an alkylene group having 2 to 4 carbon atoms, such as ethylene carbonate, propylene carbonate, or butylene carbonate. Among these cyclic carbonates, ethylene carbonate and propylene carbonate are preferred in terms of improvement in battery characteristics, and ethylene carbonate is particularly preferred.

As the chain carbonates, dialkyl carbonate is preferred, and the number of carbon atoms in the constituent alkyl groups is preferably 1 to 5, particularly preferably 1 to 4. Specifically, for example, dialkyl carbonate such as symmetrical chain alkyl carbonates such as dimethyl carbonate, diethyl carbonate, or di-n-propyl carbonate; or asymmetric chain alkyl carbonates such as ethylmethyl carbonate, methyl-n-propyl carbonate, or ethyl-n-propyl carbonate may be used. Among these chain carbonates, dimethyl carbonate is preferred because the viscosity thereof is the lowest.

However, since dimethyl carbonate has a slightly lower boiling point, more suitable characteristics can be obtained by further mixing chain carbonates having a higher boiling point. Although diethyl carbonate is preferred for the chain carbonate to be mixed, other chain carbonates can also be used without any problems.

The mixing ratio also varies in accordance with desired practical characteristics. There is an optimum composition for the ratio of chain carbonate to cyclic carbonate, including the ratio of Li salt.

The content ratio of cyclic carbonate in the electrolyte is preferably 1 to 35% by weight, more preferably 3 to 30% by weight, still more preferably 4 to 25% by weight. A plurality of cyclic carbonates can be mixed.

On the other hand, the content ratio of chain carbonate in the electrolyte is preferably 40 to 70% by weight, more preferably 43 to 68% by weight. A plurality of chain carbonates can be mixed.

The following combinations are suitable as the overall composition.

Among combinations of ethylene carbonate and dialkyl carbonates, ethylene carbonate and dimethyl carbonate are preferred, and may further contain a symmetric chain dialkyl carbonate and/or an asymmetric chain dialkyl carbonates. For example, the combination containing ethylene carbonate, symmetrical chain dialkyl carbonates, and asymmetric chain dialkyl carbonates such as ethylene carbonate, dimethyl carbonate and diethyl carbonate, ethylene carbonate, dimethyl carbonate and ethyl methyl carbonate, ethylene carbonate, dimethyl carbonate, diethyl carbonate, and ethyl methyl carbonate is preferred because of a good balance between cycle characteristics and high-output discharge characteristics. Among the above, the asymmetric chain dialkyl carbonate is preferably ethyl methyl carbonates, and further, the alkyl group of the alkyl carbonate preferably having 1 to 2 carbon atoms is preferred.

Furthermore, as the solvent that aids in dissociation or migration of ions or the like, cyclic ethers, chain ethers, cyclic carboxylic acid esters, chain carboxylic acid esters, or the like can be added in association with the main organic solvents listed above.

The cyclic ethers may be tetrahydrofuran, 2-methyltetrahydrofuran, or the like, and the chain ethers may be dimethoxyethane, dimethoxymethane, or the like.

The cyclic carboxylic acid esters may be γ-butyrolactone, γ-valerolactone, or the like, and the chain carboxylic acid esters may be, methyl acetate, methyl propionate, ethyl propionate, methyl butyrate, or the like.

Among the above, the chain carboxylic acid esters are particularly suitable.

Furthermore, it is preferable to contain fluorine-containing cyclic carbonate having two or more fluorine atoms in the electrolyte of the present embodiment.

Although the number of fluorine atoms in fluorine-containing cyclic carbonate having two or more fluorine atoms is not particularly limited in the case of fluorinated ethylene carbonate, the lower limit number is typically two or greater, and the upper limit number is typically four or less, preferably three or less.

In the case of fluorinated propylene carbonate, the lower limit number is typically two or greater, and the upper limit number is typically six or less, preferably five or less. In particular, the fluorinated propylene carbonate having two or more fluorine atoms bound to the carbon atoms forming the ring structure is preferred in terms of improvement in cycle characteristics and storage characteristics.

Among the above, fluorinated ethylene carbonate having two or more fluorine atoms is preferred in terms of improvement in battery characteristics, and furthermore, among the above, cis-4,5-difluoro-1,3-dioxolan-2-one, trans-4,5-difluoro-1,3-dioxolan-2-one or 4,4-difluoro-1,3-dioxolan-2-one is particularly preferred.

The fluorine-containing cyclic carbonate having two or more fluorine atoms may be used alone, or two or more types of the fluorine-containing cyclic carbonates may be used in combination. The ratio of the fluorine-containing cyclic carbonate compound having two or more fluorine atoms in the non-aqueous electrolyte solution is not particularly limited in achieving the effect of the present embodiment, and is typically 0.001% by weight or higher, preferably 0.01% by weight or higher, more preferably 0.1% by weight or higher, particularly preferably 0.2% by weight or higher, most preferably 0.25% by weight or higher. At a concentration lower than the above, it may be difficult to achieve the effect of the present embodiment. On the contrary, since an excessively high concentration may increase the internal pressure of the battery during high-temperature storage, the upper limit is typically 10% by weight or less, preferably 4% by weight or less, more preferably 2% by weight or less, particularly preferably 1% by weight or less, most preferably 0.5% by weight or less.

In addition, cyclic carbonates having unsaturated bonds or aromatic compounds having a total carbon number of 7 or greater and 18 or less may be mixed in the electrolyte.

Among the cyclic carbonates having an unsaturated bond, vinylene carbonate, vinylethylene carbonate, 4-methyl-4-vinylethylene carbonate, or 4,5-divinylethylene carbonate is preferred in terms of improvement in cycle characteristics, and among these cyclic carbonates, vinylene carbonate or vinylethylene carbonate is more preferred. These cyclic carbonates may be used alone, or two or more types of these cyclic carbonates may be used in combination.

As the aromatic compound having a total carbon number of 7 or greater and 18 or less, aromatic compounds such as biphenyl, alkylbiphenyl, terphenyl, partially hydrogenated terphenyl, cyclohexylbenzene, t-butylbenzene, t-amylbenzene, diphenyl ether, dibenzofuran, or the like are preferred.

When side reactions between the aromatic compound having a total carbon number of 7 or greater and 18 or less and the anode and cathode are suppressed in such a way, it is expected that the significant deterioration of discharge characteristics after high-temperature storage can be suppressed.

To achieve the effect of the present embodiment, the ratio of aromatic compound having a total carbon number of 7 or greater and 18 or less in the electrolyte is typically 0.001% by weight or higher, preferably 0.1% by weight or higher, particularly preferably 0.3% by weight or higher, most preferably 0.5% by weight or higher, the upper limit is typically 5% by weight or less, preferably 3% by weight or less, particularly preferably 2% by weight or less. At a concentration lower than this lower limit, it may be difficult to achieve the effect of improving safety during overcharging. On the contrary, an excessively high concentration may reduce the battery characteristics such as high-temperature storage characteristics.

The separator 215 separates the cathode 212 and the anode 214 from each other and allows lithium ions to pass through while preventing a short circuit of current due to contact between the two electrodes, and a porous membrane made of resin is suitably used.

As a membrane form, a stretched membrane in which pores are formed by stretching bulk resin, a nonwoven fabric in which a pore structure like a porous membrane can be created by laminating a large number of fiber-like resin fibers, or the like are suitably used.

The material for the resin may be polyolefins, and polyethylene is particularly suitable. Polyethylene has a relatively low melting temperature, and when the temperature of the battery rises for some reason (an unsafe condition such as a short circuit or the like as an example), the pores in the membrane are closed due to heat fusion, the migration of driving ions is inhibited, thereby the reaction is stopped, and safety can be ensured.

In porous membranes formed by the stretching scheme, typically, a plasticizer or the like are added to polyolefin, the plasticizer is removed before or after the stretching, and the porous membranes have a relatively uniform microporous structure from a portion as a starting point where the plasticizer has been present or the like.

In manufacturing of a stretched membrane, stretching is typically performed in both the longitudinal direction and the width direction. A suitable stretched membrane can be obtained by combining any atmospheric medium, a temperature, a speed, a stress, the number of process repetitions, or the like as appropriate, in addition to the removal of the plasticizer or the like as described above.

Although a high-quality stretched membrane can be obtained through the above manufacturing step, multiple phases of steps are required. This makes it difficult to reduce manufacturing costs such as processing costs, and this may be a negative factor in the spread of lithium-ion batteries.

In contrast, by simplifying steps so that stretching is performed only in the longitudinal direction without using a plasticizer or the like, it is possible to obtain a porous membrane that can be manufactured on an industrial scale and also reduce the manufacturing costs. In such a case, the applicable resin is polyolefin, and polypropylene is suitable used.

The separator interposed between the cathode and the anode can be any separator as long as it is formed of an electrically insulating porous body. As the separator, for example, a membrane or a fibrous nonwoven fabric made of polymer such as a polyolefin such as polyethylene and polypropylene, polyester, polyethylene terephthalate, or polyimide is applicable. As the material of the separator, a single type thereof may be used alone, or multiple types thereof may be used. Further, the separator may be of a single layer or a multilayer (composite membrane). Further, the separator may contain nano-particles of an inorganic material such as ceramic. Further, a high molecular compound such as polyvinylidene fluoride may be applied to both sides of the separator.

In the non-aqueous electrolyte battery according to the present embodiment, an electrolyte in a gel form made by containing a polymer compound that becomes a holder that swells with an organic solvent and retains the non-aqueous electrolyte may be used. This is because, when a polymer compound that swells with an organic solvent is contained, high ionic conductivity can be obtained, excellent charge/discharge efficiency can be obtained, and leakage of the battery can be prevented. When the non-aqueous electrolyte contains a polymer compound, the content of the polymer compound is preferably within a range of 0.1% by weight or greater and 10% by weight or less of the non-aqueous electrolyte.

Further, when a polymer compound such as polyvinylidene fluoride is applied to both sides of the separator, the mass ratio of the non-aqueous electrolyte to the polymer compound is preferably within a range of 50:1 to 10:1. With the mass ratio being within this range, higher charge/discharge efficiency can be obtained.

The above polymer compound may be, for example, ether-based polymer compounds such as polyvinyl formal, polyethylene oxide, and crosslinked products containing polyethylene oxide, ester-based polymer compounds such as polymethacrylate, acrylate-based polymer compounds, and polyvinylidene fluoride, and polymers of vinylidene fluoride such as copolymers of vinylidene fluoride and hexafluoropropylene. A single type of polymer compound may be used alone, or multiple types thereof may be used as a mixture. In particular, in terms of the effect of preventing swelling during high-temperature storage, it is desirable to use a fluorine-based polymer compound such as polyvinylidene fluoride.

The lithium-ion battery having the configuration as described above operates as follows.

When the lithium-ion battery is charged, Li ions contained in the cathode 212 pass through the separator 215 and are inserted between layers of the layered structure of graphite contained in the anode 214. Then, when the energy storage device is discharged, Li ions are released from between the layers the layered structure included in the anode 214, pass through the separator 215, and return to the cathode 212. With a series of these operations, the battery reaction proceeds.

Although one embodiment of the present invention has been described in detail above, the present invention is not limited to the above embodiment, and various modifications and changes are possible within the scope not departing from the spirit of the present invention recited in the claims.

Although the coin cell lithium-ion battery has been described as the lithium-ion battery as an example in the above embodiment, the lithium-ion battery of the present embodiment can be similarly applied to batteries having other shapes such as a button type, a paper type, a rectangular type, or a cylindrical type with spiral structure. Further, the lithium-ion battery of the present embodiment can have various sizes such as a thin device or a large device.

Furthermore, although the embodiment assuming the case of the lithium-ion battery having a liquid electrolyte as the electrolyte used for the lithium-ion battery according to the present embodiment has been expressed in the above description, any other electrolytes can be applicable. To give some examples, gel electrolytes or solid electrolytes can also be suitably used.

### EXAMPLES

### Experiment 1: Confirmation of Fundamental Performance of Battery Reaction Auxiliary Material

### Example 1

### Manufacturing of Battery Reaction Auxiliary Material

Magnesium oxide nano-powder (primary particle size of 0.4 μm, SSA 130 m²/g; by Guangzhou Hongwu Material Technology Co., Ltd.) was filled as a template of a carbonaceous film in a heat treatment container, which was loaded in a tube reactor. The inside thereof is replaced with an Ar gas and then heated up to 920° C. Pre-heat treatment was added for the purpose of dehydration or the like, if necessary. A mixture gas of an Ar gas and a CH₄ gas (at concentration of 20% by volume) is then allowed to flow for 2.3 hours, and the carbonaceous film including graphene structure was formed on the template by the T-CVD method. After cooling, the template with the carbonaceous film was taken out and subjected to crushing and classification process.

Next, the template was eluted from this processed material with hydrochloric acid and, while the intraparticle space was maintained, washed and dried to obtain auxiliary material precursor. This was subjected to heat treatment at 1700° C. in an inert atmosphere to optimize the carbon structure and obtain the battery reaction auxiliary material of Example 1.

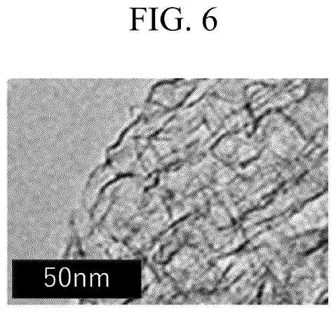

For the obtained auxiliary material, the shape thereof was observed by TEM using a transmission electron microscope (JEM-2010, JEOL Ltd.). The observation of the porous carbon material using a transmission electron microscope was performed at an acceleration voltage of 200 kV. The average particle size of the secondary particles of the obtained auxiliary material was 3.2 μm, and it was observed from a transmission electron microscopy (TEM) image (FIG. 6) that layered graphene frame structure was mainly formed.

### Ultra-Micro Loading and Unloading Test

A small amount of the auxiliary material dispersed in ethanol was spread and dried on a sample table. The auxiliary material was then introduced into SEM, particles in measurement were observed, and particles having a height of 1 to 5 μm and a width of 1 to 5 m were arranged as a measurement target right under an intender. A load-unload test was then performed by using Nano-indenter: Nano Flip (Toyo Technica) embedded in the SEM under conditions of a pushing head: InForce50, an intender diameter: 10 μm, the maximum load: 0.1 mN, the time to maximum load: 5 sec, and the maximum load duration: 5 sec. One or more samples stably fixed to the sample table were selected, and the forms thereof were re-measured when the position changed easily at the initial phase of pressurizing. The plastic deformation power illustrated in FIG. 4 can be found from the following formula.

$$Plastic deformation power = \frac{Plastic deformation workload}{\begin{matrix}( Plastic deformation workload + \\ Elastic deformation workload )\end{matrix}} \qquad [ Math 1 ]$$

### Production of Cathode Electrode

Herein, 96% by weight of ternary cathode material NCM (LiNi_{0.5}Co_{0.2}Mn_{0.3}O₂) powder of the average particle size of 8 μm, 1% by weight of the battery reaction auxiliary material of Example 1 as the conductive auxiliary agent, and 3% by weight of PVdF were added to N-methyl-pyrrolidone (NMP) that is a solvent. The obtained mixture solution was stirred and mixed so as to be uniform to produce a cathode material paste. This was applied onto an Al current collector having a thickness of 15 μm and then dried at 110° C., and the applied Al current collector was punched out into Φ15 mm and pressurized at 45 kN into a cathode electrode.

### Production of Test Battery for Cathode

After the obtained cathode electrode was dried under vacuum at 120° C., a polypropylene separator was used with 1M of LiPF₆ solution (mixture solvent of ethylene carbonate (EC):diethyl carbonate (DEC)=1:1) as an electrolyte solution in a glove box of an argon gas atmosphere to produce a coin cell test battery of 2032 size having a metal Li counter electrode.

### Evaluation Method for Cathode

Each test battery was subjected to conduction at constant current of 1.25 mA (corresponding to 0.2C) until the voltage became 4.2 V and, after 4.2 V was reached, charged at a constant voltage, and this operation was continued until the current became 0.31 mA (0.05C). The test battery was then discharged at constant current of 1.25 mA until the voltage became 3 V. The discharge capacity and the average voltage at this time were found. Next, the same test battery was used and subjected to conduction at constant current of 1.25 mA (corresponding to 0.2C) until the voltage became 4.2 V and, after 4.2 V was reached, charged at a constant voltage, and this operation was continued until the current became 0.31 mA (0.05C). The test battery was then discharged at constant current of 12.5 mA (corresponding to 2C), which is a high rate, until the voltage became 3 V. From the obtained discharge capacity of the test battery, the 2C retention rate (2C capacity/0.2C capacity) of each test battery was found.

### Example 2

Aluminum oxide nano-powder (primary particle size of 0.015 μm, SSA 157 m²/g; by TECNAN) was used as a template of the carbonaceous film, and the battery reaction auxiliary material of Example 2 was obtained by the same operation as in Example 1 except that the heat treatment temperature was 890° C., the time of the T-CVD method was 2.1 hours, and hydrofluoric acid was used for elution of the template.

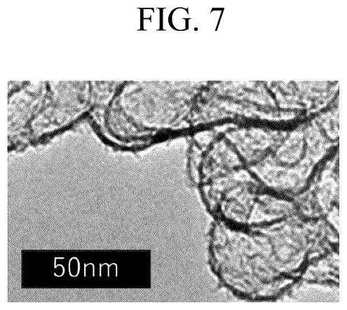

In the obtained auxiliary material of Example 2, formation of the layered graphene frame structure was mainly observed by a transmission electron microscope (TEM) (FIG. 7), and the average particle size of the secondary particle was 2.1 μm.

The test battery of Example 2 was manufactured under the same conditions as in Example 1.

### Comparative Example 1

A test battery was manufactured under the same conditions as in Example 1 except that acetylene black (by Denka Company Limited, product name: Denka Black) was used instead of the auxiliary material.

### Comparative Example 2

A test battery was manufactured under the same conditions as in Example 1 except that Ketjen black (by LION SPECIALTY CHEMICALS CO., LTD., product name: EC300) was used instead of the auxiliary material.

### Comparative Example 3

A test battery was manufactured under the same conditions as in Example 1 except that single-wall carbon nanotubes (SSA: 600 m²/g, outer diameter: 2 nm, length: 2 to 5 μm; Guangzhou Hongwu Material Technology Co., Ltd.) were used instead of the auxiliary material, the additive amount of the cathode in battery production was 97.95% by weight, and the additive amount of the single-wall carbon nanotubes was 0.05% by weight.

In addition to the ultra-micro loading and unloading test described above, nitrogen adsorption/desorption measurement, and Raman spectroscopy measurement were performed on the battery reaction auxiliary materials manufactured in Examples 1 and 2, acetylene black used in Comparative example 1, Ketjen black used in Comparative example 2, and single-wall carbon nanotubes used in Comparative example 3 to find the plastic deformation power, the pore volume, the carbon layer stacking index, respectively.

The measurement of pore volumes by nitrogen adsorption/desorption for the auxiliary materials of Examples was performed under the condition of −196° C. by using a specific surface area and pore distribution measuring device (by BELSORP MAX, BEL Japan). Before measurement, degassing treatment of vacuum drying at 150° C. for 6 hours was performed. The equilibrium judgment condition in measuring the pressure inside a sample tube was set to 300 seconds.

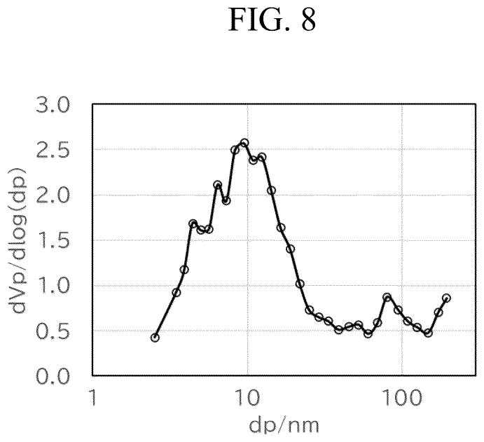

The obtained nitrogen adsorption/desorption isotherm data was analyzed by using software Autosorb 1 (by Anton Paar Japan K.K.). In a case of I-type adsorption isotherm, the distribution of diameters of electrolyte solution conduction holes was analyzed with reference to a kernel calculated by the density functional theory (DFT method) assuming a slit type hole. Further, for samples exhibiting IV-type adsorption isotherm, pore volumes were found by applying the Barrett-Joyner-Halenda method (BJH method) to respective adsorption isotherms to analyze the pore diameter distribution. FIG. 8 illustrates the pore diameter distribution curve of the auxiliary material of Example 1.

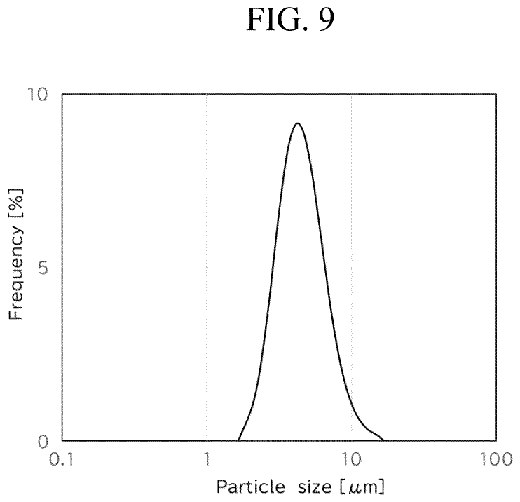

Particle size distribution measurement was performed on the auxiliary materials of the Examples by using laser diffraction particle size distribution measurement device (by Microtrak Bell Co., Ltd., MT3300EXII-SDC). Specifically, water was added to respective auxiliary materials, ethanol was further mixed before measurement, a three-frequency ultrasonic cleaner (by Azone Co., Ltd., VS-100III) was used to perform ultrasonic treatment for 5 minutes, and the particle size distribution measurement was then performed by using the above device. FIG. 9 illustrates the particle size distribution of the auxiliary material of Example 1.

The Raman spectrum was measured for the auxiliary materials of the Examples by using a microscopic Raman spectrometer (DXR3 Microscopic Laser Raman; by Thermo Fisher Scientific). The laser of 532 nm (2 mW) was used for measurement, and the measurement was performed at settings of grating: 900 lines/mm, spectrometer aperture: 50 μmΦ, exposure time: 0.500 sec (2 Hz), cumulative number: 10 (5 min). The measurement range was 300 to 350 cm⁻¹. FIG. 2 illustrates the Raman spectrum measured for the auxiliary material of Example 1.

Next, the carbon layer stacking index represented by I_{G}/I_{2D} was found from values of the G-band and the 2D-band obtained by the measurement.

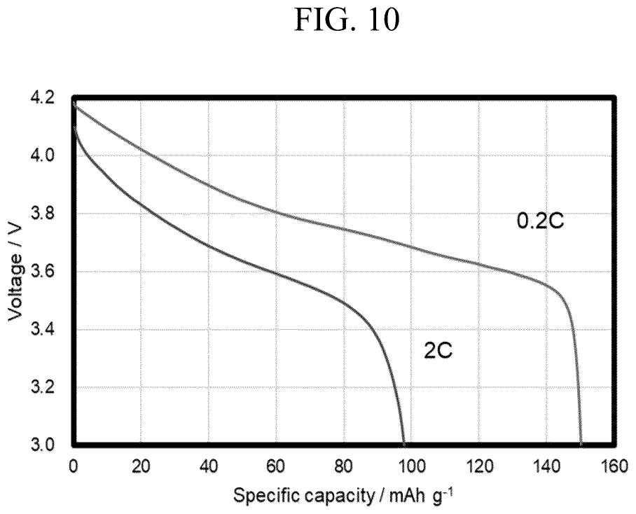

For the test batteries of Examples 1, 2 and Comparative examples 1 to 3, the 2C retention rate was found as a battery discharge rate characteristic by the evaluation method for cathodes described above. Table 1 lists the result thereof. Further, FIG. 10 illustrates discharge curves for different current values during discharging using the test battery of Example 1.

TABLE 1

| | Amount of | Plastic | | Secondary | |
|---|---|---|---|---|---|
| | intra- | defor- | | particle | 2C-rate |
| | particle | mation | | average | discharge |
| | space | workload | I_{G}/ | particle | retention |
| | (cc/g) | (%) | I_{2D} | size (μm) | rate |
| Example 1 | 2.2 | 76 | 2.4 | 3.2 | 0.65 |
| Example 2 | 3.9 | 62 | 1.9 | 2.1 | 0.55 |
| Comparative | 0.90 | 3 | 7.2 | 4.6 | 0.22 |
| example 1 | | | | | |
| Comparative | 0.79 | 3 | 6.2 | 6 | 0.36 |
| example 2 | | | | | |
| Comparative | 0.92 | 2 | 4 | 1.6 | 0.19 |
| example 3 | | | | | |

### Discussion

It was confirmed that the auxiliary materials of the present Examples exhibit a higher retention rate of high-rate discharge than the conductive agent of the Comparative examples. Further, it was implied from values of the carbon layer stacking index represented by I_{G}/I_{2D} that the auxiliary materials of the Examples have graphene structure in at least a part of the structure of the auxiliary materials.

The auxiliary materials of the present Examples have a moderate mechanical property, that is, plastic deformability such that force above a certain level causes plastic deformation and force below a certain level causes elastic deformation. The auxiliary materials of the present Examples are formed of a three-dimensional frame made of a graphene substance with small number of layers. Thus, the auxiliary materials have a nature that the high-quality graphene substance can maintain electron conduction even when permanent deformation occurs due to the plasticity while leaving a pore volume in the auxiliary material and retaining the electrolyte solution due to the elasticity between particles of the cathode material in the electrode. This nature is one of the advantageous features of the auxiliary materials of the present Examples.

### Experiment 2: Comparison Between Battery Reaction Auxiliary Material and Existing Conductive Agent

### Example 3

A test battery was manufactured and battery evaluation was performed under the same conditions as in Example 1 except that the additive amount of the auxiliary material of Example 1 to the cathode was 0.5% by weight and the additive amount of acetylene black (SSA: 65 m²/g, by Denka Company Limited, product name: Denka Black) to the cathode was 0.5% by weight.

### Example 4

A test battery was manufactured and battery evaluation was performed under the same conditions as in Example 1 except that the additive amount of the auxiliary material of Example 1 to the cathode was 0.5% by weight and the additive amount of Ketjen black (SSA: 800 m²/g, by LION SPECIALTY CHEMICALS CO., LTD., product name: EC300) to the cathode was 0.5% by weight.

### Example 5

A test battery was manufactured and battery evaluation was performed under the same conditions as in Example 1 except that the additive amount of the cathode material was 96.45% by weight, the additive amount of the auxiliary material of Example 1 to the cathode was 0.5% by weight, and the additive amount of single-wall carbon nanotubes (SSA: 700 m²/g, outer diameter: 2 nm, length: 2 to 5 μm; Guangzhou Hongwu Material Technology Co., Ltd.) to the cathode was 0.05% by weight.

### Example 6

The battery reaction auxiliary material of Example 6 was obtained by the same operation as in Example 2 except that the template was not eluted (namely, ceramic particles remain).

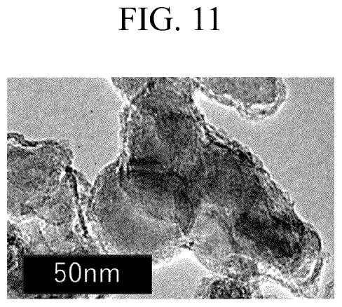

For the obtained auxiliary material of Example 6, a view in which the layered graphene structure was mainly formed on the template particles and the template was present inside was observed by a transparent electron microscope (TEM) (FIG. 11).

A test battery was manufactured and battery evaluation was performed under the same conditions as in Example 1 except that the additive amount of the auxiliary material of Example 1 to the cathode was 0.5% by weight and the additive amount of the auxiliary material of Example 6 to the cathode was 0.5% by weight.

Table 2 lists the results of battery evaluation for the test batteries of Examples 3 to 6.

TABLE 2

| | 2C-rate discharge |
|---|---|
| | retention rate |
| Example 3 | 0.44 |
| Example 4 | 0.62 |
| Example 5 | 0.33 |
| Example 6 | 0.67 |

### Discussion

When the auxiliary material of the present Examples were mixed to the conductive agent used in Comparative examples and the mixture is used for the electrode, the retention rate of high-rate discharge was higher than in a case where the conductive agents of Comparative examples were used alone (Comparative examples 1 to 3). While the dimension and the shape differ for some types of conductive agents, the Ketjen black having fine pores inside and having a larger specific surface area compared to the acetylene black exhibited a more significant effect among the types of carbon black with nanoparticles that are primary particles being aggregated. This is considered to be because the Ketjen black has many oxygen functional groups and thus is less likely to aggregate with the auxiliary material of the present invention.

On the other hand, in Example 6 with ceramics hollow particles, substantially the same level of 2C retention rate as in Example 4 was obtained. This is considered to be because relatively large voids inside the electrode were less likely to collapse allowing the presence of a relatively large amount of the electrolyte solution and the good result was thus obtained.

### Experiment 3: Study of Synthesis Condition for Battery Reaction Auxiliary Material of Example 1

In the auxiliary materials of the present Examples, a carbonaceous film is formed to ceramics by the T-CVD method. The auxiliary materials having carbonaceous films with different thicknesses or properties were produced by changing the gas flowing time while maintaining a constant concentration of the organic gas in the mixture gas as with Examples 1 and 7 to 10 and Comparative example 4.

### Example 7

A battery reaction auxiliary material of Example 7 was obtained with the same operation as in Example 1 except that the mixture gas was caused to flow for 0.5 hours by the T-CVD method.

### Example 8

A battery reaction auxiliary material of Example 8 was obtained with the same operation as in Example 1 except that the mixture gas was caused to flow for 1.0 hour by the T-CVD method.

### Example 9

A battery reaction auxiliary material of Example 9 was obtained with the same operation as in Example 1 except that the mixture gas was caused to flow for 1.6 hours by the T-CVD method.

### Example 10

A battery reaction auxiliary material of Example 10 was obtained with the same operation as in Example 1 except that the mixture gas was caused to flow for 3.0 hours by the T-CVD method.

### Example 11

A battery reaction auxiliary material of Example 11 was obtained with the same operation as in Example 1 except that the mixture gas was caused to flow for 5.0 hours by the T-CVD method.

### Example 12

The carbonaceous film including graphene structure was formed on a template by the T-CVD method of Example 2 and then cooled. A battery reaction auxiliary material of Example 12 was obtained with the same operation as in Example 2 except that, after taken out, the template with the carbonaceous film was not crushed and classified and not subjected to the heat treatment in the inert gas atmosphere.

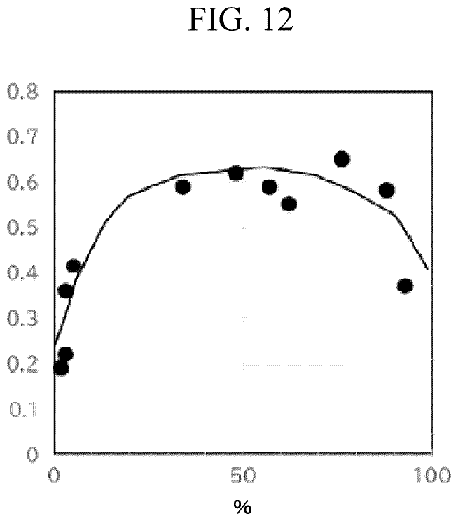

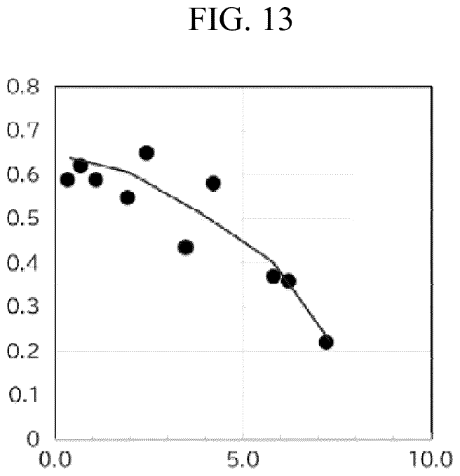

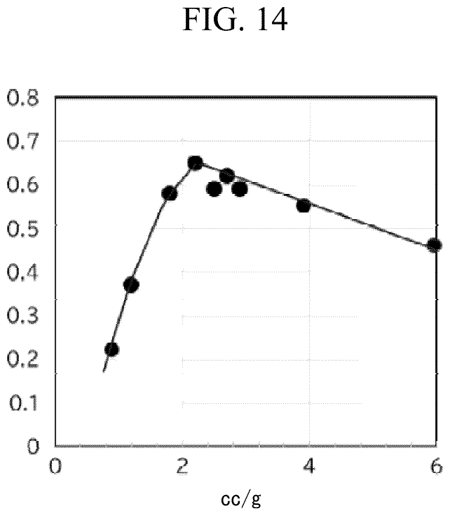

In the same manner as in Example 1, the test batteries were manufactured by using the battery reaction auxiliary materials of Example 7 to Example 12. For these test batteries, various tests and battery evaluation were performed, and Table 3 and FIG. 12, FIG. 13, and FIG. 14 illustrate the results. Table 3 also lists the evaluation of Comparative examples 1 to 3 together. FIG. 12 is a diagram illustrating the relationship between the plastic deformation power and the 2C-rate discharge retention rate of the test batteries according to Examples 1, 2, and 7 to 12 and the test batteries according to Comparative examples 1 to 3. In FIG. 12, the vertical axis represents the 2C-rate discharge retention rate, and the horizontal axis represents plastic deformation power. FIG. 13 is a diagram illustrating the relationship between the carbon layer stacking index and the 2C-rate discharge retention rate of the test batteries according to Examples 1, 2, and 7 to 12 and the test batteries according to Comparative examples 1 and 2. In FIG. 13, the vertical axis represents the 2C-rate discharge retention rate, and the horizontal axis represents the carbon layer stacking index. FIG. 14 is a diagram illustrating the relationship between the pore volume and the 2C-rate discharge retention rate of the test batteries according to Examples 1, 2, and 7 to 12 and the test batteries according to Comparative example 1. In FIG. 14, the vertical axis represents the 2C-rate discharge retention rate, and the horizontal axis represents the pore volume.

TABLE 3

| | Amount | Plastic | | 2C-rate |
|---|---|---|---|---|
| | of intra- | deformation | | discharge |
| | particle | workload | I_{G}/ | retention |
| | space (cc/g) | (%) | I_{2D} | rate |
| Example 7 | 2.9 | 34 | 0.3 | 0.59 |
| Example 8 | 2.7 | 48 | 0.65 | 0.62 |
| Example 9 | 2.5 | 57 | 1.07 | 0.59 |
| Example 1 | 2.2 | 76 | 2.4 | 0.65 |
| Example 10 | 1.8 | 88 | 4.2 | 0.58 |
| Example 11 | 1.2 | 93 | 5.8 | 0.37 |
| Example 12 | 6.0 | 5 | 3.57 | 0.42 |
| Comparative | 0.92 | 2 | 4 | 0.19 |
| example 3 | | | | |
| Comparative | 0.90 | 3 | 7.2 | 0.22 |
| example 1 | | | | |
| Comparative | 0.79 | 3 | 6.2 | 0.36 |
| example 2 | | | | |

### Discussion

As can be seen from the results in Table 3 and FIG. 12 to FIG. 14, the high-rate characteristics were shown suitably in a range of the evaluation test of the Examples. This is a range where the balance between the elastic deformation and the plastic deformation is suitable. In other words, this is considered to be because the balance between the electron conductivity and ion conductivity is suitable.

For the relationship between the carbon layer stacking index and the 2C-rate discharge retention rate (FIG. 13), it was confirmed that the carbon layer stacking indices in the test batteries of the Examples are in a range of 0.3 to 5.8 and all these test batteries exhibit higher rate characteristics than the test batteries of Comparative examples 1 and 2. This is considered to be due to the face that the electrodes of the test batteries according to the Examples include graphene and thus are superior in electron transfer.

Further, for the relationship between the pore volume and the 2C-rate discharge retention rate (FIG. 14), it was confirmed that all the test batteries according to the Examples exhibit higher rate characteristics than the test battery of Comparative example 1. This is considered to be due to the fact that a larger pore volume allows more electrolyte solution containing dissolved lithium ions to permeate and increase the storage amount and thus results in superior ion supply during a battery reaction.

### Experiment 4: Study of Secondary Particle Size of Battery Reaction Auxiliary Material

### Example 13

A battery reaction auxiliary material of Example 13 was obtained with the same operation as in Example 1 except for a change in the crushing and classification process conditions. The average particle size of the secondary particles of the obtained auxiliary material was 0.4 μm.

### Example 14

A battery reaction auxiliary material of Example 14 was obtained with the same operation as in Example 1 except for a change in the crushing and classification process conditions. The average particle size of the secondary particles of the obtained auxiliary material was 1.3 μm.

### Example 15

A battery reaction auxiliary material of Example 15 was obtained with the same operation as in Example 1 except for a change in the crushing and classification process conditions. The average particle size of the secondary particles of the obtained auxiliary material was 4.9 μm.

### Example 16

A battery reaction auxiliary material of Example 16 was obtained with the same operation as in Example 1 except for a change in the crushing and classification process conditions. The average particle size of the secondary particles of the obtained auxiliary material was 0.1 μm.

### Example 17

A battery reaction auxiliary material of Example 17 was obtained with the same operation as in Example 1 except for a change in the crushing and classification process conditions. The average particle size of the secondary particles of the obtained auxiliary material was 6.0 μm.

### Comparative Example 4

A battery reaction auxiliary material of Comparative example 4 was obtained with the same operation as in Example 1 except for a change in the crushing and classification process conditions. The average particle size of the secondary particles of the obtained auxiliary material was 6.8 μm.

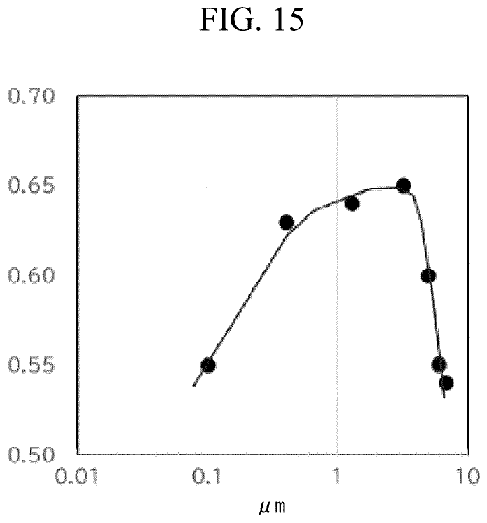

In the same manner as in Example 1, the test batteries were manufactured by using the battery reaction auxiliary materials of Examples 13 to 17 and Comparative example 4. For these test batteries, various tests and battery evaluation were performed, and Table 4 and FIG. 15 illustrate the results. FIG. 15 is a diagram illustrating the relationship between the secondary particle average particle size in the auxiliary material and the 2C-rate discharge retention rate for the test batteries according to Examples 1 and 13 to 17 and the test batteries according to Comparative example 4. In FIG. 15, the vertical axis represents the 2C-rate discharge retention rate, and the horizontal axis represents the secondary particle average particle size.

TABLE 4

| | Secondary particle average | 2C-rate discharge |
|---|---|---|
| | particle size (μm) | retention rate |
| Example 13 | 0.4 | 0.63 |
| Example 14 | 1.3 | 0.64 |
| Example 1 | 3.2 | 0.65 |
| Example 15 | 4.9 | 0.60 |
| Example 16 | 0.1 | 0.56 |
| Example 17 | 6.0 | 0.55 |
| Comparative | 6.8 | 0.54 |
| example 4 | | |

### Discussion

From the results in Table 4 and FIG. 15, it was confirmed that, while the high-rate characteristics suitably change in a range of the particle size of the auxiliary materials of the present Examples 1 and 13 to 17, the intended characteristics are reduced for excessively small particle sizes and excessively large particle sizes. An excessively small particle size adversely affects the characteristics, because the auxiliary material is destroyed by crushing, the graphene face that is responsible for electron conduction becomes smaller, and the intraparticle space that is responsible for ion retention becomes smaller. In contrast, an excessively large particle size results in poor dispersion of the auxiliary material in the electrode, this causes insufficient development of electron conductive paths, and the performance is not sufficiently exerted.

### Experiment 5: Study of Additive Amount of Battery Reaction Auxiliary Material of Example 1

### Example 18

The test battery was produced in the same manner as in Example 1 except that the additive amount of the cathode material is 96.9% by weight and the additive amount of the auxiliary material of Example 1 to the cathode is 0.1% by weight.

### Example 19

The test battery was produced in the same manner as in Example 1 except that the additive amount of the cathode material is 96.5% by weight and the additive amount of the auxiliary material of Example 1 to the cathode is 0.5% by weight.

### Example 20

The test battery was produced in the same manner as in Example 1 except that the additive amount of the cathode material is 95.0% by weight and the additive amount of the auxiliary material of Example 1 to the cathode is 2.0% by weight in production of the test battery.

### Example 21

The test battery was produced in the same manner as in Example 1 except that the additive amount of the cathode material is 95.0% by weight and the additive amount of the auxiliary material of Example 1 to the cathode is 4.0% by weight in production of the test battery.

### Comparative Example 5

The test battery was produced in the same manner as in Example 1 except that the additive amount of the cathode material is 96.95% by weight and the additive amount of the auxiliary material of Example 1 to the cathode is 0.05% by weight in production of the test battery.

### Comparative Example 6

The test battery was produced in the same manner as in Example 1 except that the additive amount of the cathode material is 90.0% by weight and the additive amount of the auxiliary material of Example 1 to the cathode is 7.0% by weight in production of the test battery.

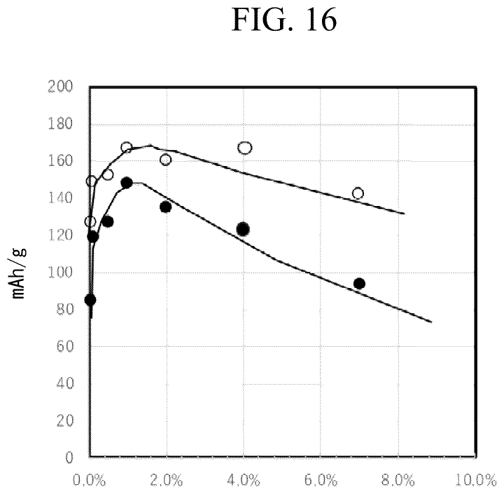

A charging/discharging test was performed on the test batteries of Examples 18 to 21 and Comparative examples 5 and 6. Each test battery was subjected to conduction at constant current of 1.25 mA (corresponding to 0.2C) until the voltage became 4.2 V and, after 4.2 V was reached, charged at a constant voltage, and this operation was continued until the current became 0.31 mA (0.05C). The test battery was then discharged at constant current of 1.25 mA until the voltage became 3 V. The charge capacity and the discharge capacity at this time were found. Table 5 and FIG. 16 illustrate the results. FIG. 16 is a diagram illustrating the relationship between the additive amount of the auxiliary material and the charge/discharge capacity for the test batteries according to the Examples and the test batteries according to the Comparative examples. In FIG. 16, the vertical axis represents the capacity, and the horizontal axis represent the additive amount, each white circle (o) is a plot representing a charge capacity, and each black circle (e) is a plot representing a discharge capacity.

TABLE 5

| | Additive | Charge | Discharge |
|---|---|---|---|
| | amount | capacity | capacity |
| | (wt %) | (mAh/g) | (mAh/g) |
| Example 18 | 0.10 | 149 | 119 |
| Example 19 | 0.50 | 152 | 127 |
| Example 1 | 1.0 | 167 | 148 |
| Example 20 | 2.0 | 160 | 135 |
| Example 21 | 4.0 | 150 | 111 |
| Comparative | 0.05 | 127 | 85 |
| example 5 | | | |
| Comparative | 7.0 | 142 | 94 |
| example 6 | | | |

### Discussion

From the results of Table 5 and FIG. 16, it was confirmed that the high-rate characteristics of the test batteries suitably change in the range of additive amounts of the auxiliary materials of Examples 1 and 18 to 21. From comparison with the result of the Comparative examples, it was indicated that an excessively large additive amount of the auxiliary material reduces the content of the active material and reduces the charge/discharge capacity of the electrode, and an excessively small additive amount of the auxiliary material makes it difficult to exert the function of the auxiliary material.

### Experiment 6: Study of Anode Containing Battery Reaction Auxiliary Material of Example 1

### Example 22

An anode test battery was manufactured with the additive amount of 1.0% by weight of the auxiliary material of Example 1 to the anode. An anode material paste was produced by stirring and mixing 97% by weight of artificial graphite, 1% by weight of the auxiliary material of Example 1, 1% by weight of carboxymethyl cellulose, and 1% by weight of styrene-butadiene rubber (SBR) to be uniform with distilled water as a solvent. The obtained paste was applied onto the copper foil with a thickness of 20 μm and then dried at 110° C., and the copper foil was then punched out into Φ15 mm and pressurized at 30 kN into an anode electrode.

After the obtained anode electrode was dried under vacuum at 120° C., a polypropylene separator was used with 1M of LiPF₆ solution (mixture solvent of ethylene carbonate (EC): diethyl carbonate (DEC)=1:1) as an electrolyte solution in a glove box of an argon gas atmosphere to produce a coin cell test battery of 2032 size having a metal Li counter electrode.

Each test battery was subjected to conduction at constant current of 1.23 mA (corresponding to 0.2C) until the voltage became 0 V and, after 0 V was reached, charged at a constant voltage, and this operation was continued until the current became 0.31 mA (0.05C). The test battery was then discharged at constant current of 1.23 mA until the voltage became 1.5 V. The discharge capacity at this time was found. Next, the same test battery was used and subjected to conduction at constant current of 1.23 mA (corresponding to 0.2C) until the voltage became 0 V and, after 0 V was reached, charged at a constant voltage, and this operation was continued until the current became 0.31 mA (0.05C). The test battery was then discharged until the voltage became 1.5V at a high rate of constant current of 12.3 mA (corresponding to 2C). The 2C retention rate (2C capacity/0.2C capacity) was found from the discharge capacity of the test battery found in the above evaluation test. As a result of evaluation performed on the obtained anode battery, the retention rate at 2C discharge was 0.45.

### Comparative Example 7

An anode test battery was manufactured in the same manner as in Example 22 except that acetylene black (by Denka Company Limited, product name: Denka Black) was used as a conductive agent instead of the auxiliary material of Example 1 and the additive amount of this conductive agent to the anode was 1.0% by weight. As a result of evaluation performed on the obtained anode battery, the retention rate at 2C discharge was 0.23.

### Discussion

From the above result, it was confirmed that the auxiliary material of the present invention effectively works in an anode.

As is clear from the Examples described above, the retention rate of the high-rate discharge in the batteries with the auxiliary material of the present embodiment is higher than the retention rate in the batteries of the Comparative examples. This is because the auxiliary material of the present embodiment has high electron conductivity. That is, this is because, in comparison with the conductive agent used in the Comparative examples, the auxiliary material of the present embodiment has a frame of a high-conductive carbonaceous substance including a graphene substance and has a space that can retain the electrolyte solution inside each particle. The discharge reaction is a reaction in which lithium ions released during charging return to the cathode material. Once discharging starts, electrons flow into the cathode from the external circuit, these electrons and lithium ions are bound to each other, return to the cathode crystal structure site, and restore the before-charged binding state. That is, binding of lithium ions with electrons and the phase change of the crystal structure of the cathode occur simultaneously. The phase change can be observed from a change in the voltage. For a high retention rate of the high-rate discharge, this “simultaneousness” of the phase change is important, and it was confirmed that the auxiliary material of the present Examples can achieve this “simultaneousness”.

Further, it is considered that the auxiliary material of the present embodiment present in the electrode can suppress leakage of the electrolyte solution (electrolyte motion) present inside particles by a highly flexible carbonaceous substance frame including the graphene substance against an expansion pressure to the electrode generated by charging and can maintain the state where ions required at the next discharging can be smoothly supplied. The auxiliary material of the present embodiment is a material that can retain and maintain the electrolyte solution in the electrode uniformly, in particular, is expected to have a high potential for being able to mitigate an impact of electrolyte motion due to electrode internal stress in larger practical batteries (circular cylindrical type, rectangular type, pouch type, CTP type, blade type, or the like) and suppress cycle degradation.

The present invention is not limited to the embodiment or Examples described above. Forms with design changed in various ways within the scope without departing from the scope of the present invention are included in the present invention.

### REFERENCE SIGNS LIST

1 primary particle
2 secondary particle
3 cathode material
200 lithium-ion battery
211 exterior component
212 cathode
213 exterior component
214 anode
215 separator
217 sealing gasket
218 spring
219 spacer

1. A battery reaction auxiliary material comprising a plurality of primary particles, each of the primary particles including a carbonaceous substance and having a three-dimensional frame internally including a space,
wherein some of the plurality of primary particles are adhered to each other to form a secondary particle, and
wherein the secondary particle is plastically deformed in an ultra-micro loading and unloading test, and a part of the secondary particle is not restored.

2. The battery reaction auxiliary material according to claim 1, wherein the carbonaceous substance includes graphene.

3. The battery reaction auxiliary material according to claim 1, wherein the battery reaction auxiliary material has a plastic deformation power that is greater than or equal to 5% and less than or equal to 92%.

4. The battery reaction auxiliary material according to claim 1, wherein the battery reaction auxiliary material has an electron transferring function and an electrolyte retaining function as a battery reaction auxiliary function.

5. The battery reaction auxiliary material according to claim 1, wherein a pore volume measured by a gas adsorption method is greater than or equal to 1 cc/g and less than or equal to 6 cc/g.

6. The battery reaction auxiliary material according to claim 1, wherein the battery reaction auxiliary material has a carbon layer stacking index that is greater than or equal to 0.4 and less than or equal to 5.

7. The battery reaction auxiliary material according to claim 1, wherein the secondary particle is hollow, and a solid particle is mixed to the secondary particle.

8. The battery reaction auxiliary material according to claim 7, wherein the solid particle is at least one of carbon black, acetylene black, single-wall carbon nanotubes, and multi-wall carbon nanotubes.

9. The battery reaction auxiliary material according to claim 7, wherein the solid particle is formed of a ceramic particle covered with a carbonaceous substance.

10. The battery reaction auxiliary material according to claim 1, wherein the average particle size of the secondary particle is greater than or equal to 0.05 μm and less than or equal to 6 μm.

11. A cathode or an anode used for a lithium-ion battery, wherein the content of the battery reaction auxiliary material according to claim 1 is greater than or equal to 0.1% by weight and less than or equal to 5% by weight.

12. The cathode or the anode used for a lithium-ion battery according to claim 11 comprising a permanently deformed portion in a part of the structure of the cathode or the anode, the secondary particle of the battery reaction auxiliary material being permanently deformed to be the permanently deformed portion.

13. The cathode or the anode used for a lithium-ion battery according to claim 12 including multi-layer graphene in the permanently deformed portion.

14. A cathode or an anode used for a lithium-ion battery including only the solid particle according to claim 9 as the battery reaction auxiliary material.

15. A lithium-ion battery comprising at least one of the cathode and the anode according to claim 13.

16. A manufacturing method of a cathode or an anode used for a lithium-ion battery, the manufacturing method comprising steps of:
mixing a battery reaction auxiliary material, a binder resin, and a solvent to prepare slurry, the battery reaction auxiliary material containing a plurality of primary particles and a secondary particle having the plurality of primary particles adhered to each other, each of the primary particles including a carbonaceous substance and having a three-dimensional frame internally including a space; and
applying the slurry onto a current collector, drying the slurry, and performing press machining on the slurry and the current collector to obtain a cathode or an anode,
wherein in the press machining, the shape of a part of the primary particles and the secondary particle remains deformed, and the shape of another part of the primary particles and the secondary particle is restored.

17. A lithium-ion battery comprising at least one of the cathode and the anode according to claim 14.
